(19) United States
(12) Patent Application Publication
(10) Pub. No.: US 2007/0039599 A1
(43) Pub. Date: Feb. 22, 2007

(54) Low profile ignition apparatus

(76) Inventors: Albert Anthony Skinner, El Passo, TX (US); Mark Albert Paul, El Paso, TX (US); Harry Oliver Levers JR., El Paso, TX (US); Colin Hamer, El Paso, TX (US)

Correspondence Address: JIMMY L. FUNKE;DELPHI CORPORATION, M/C 480-410-202, P.O. BOX 5052, TROY, MI, 48007-5052, US

(21) Appl. No.: 11/209,110

(22) Filed: Aug. 22, 2005

(51) Int. Cl. F02P 3/02; H01F 38/12

(52) U.S. Cl. 123/647; 123/635; 123/634

(57) ABSTRACT

An ignition apparatus having a pencil coil transformer assembly extending along a first axis is mounted horizontally in a case that is directed mounted to an internal combustion engine. The ignition apparatus is installed by insertion into a spark plug well where the spark plug well has a main axis. The case includes a high voltage tower and connector terminal extending along a second axis. Upon installation when the HV tower is inserted into the spark plug well, the second axis is aligned with the main axis, and where the first axis of the pencil coil transformer assembly is perpendicular to and offset from the second axis to provide a low profile.

### BACKGROUND OF THE INVENTION

1. Technical Field

The present invention relates generally to an ignition apparatus or coil, and, more particularly, to a low profile ignition apparatus.

2. Discussion of the Background Art

An ignition apparatus for producing a spark for ignition of an internal combustion engine has been developed in a variety of different configurations suited for the particular application desired. For example, it is known to provide an ignition apparatus for “pencil” coil applications. A pencil coil is one having a relatively slender configuration adapted for mounting directly to a spark plug in a spark plug well of an internal combustion engine. A feature of a “pencil” coil is that a substantial portion of the transformer (i.e., a central core and primary and secondary windings) is located within the spark plug well itself, thereby improving space utilization in an engine compartment. Engine and/or engine compartment configurations have historically driven design configurations for pencil coils. For example, engines using ISO M14 size thread spark plugs typically have a spark plug well that is about 23 mm in diameter and pencil coils that fit in this well are typically 22 mm in diameter. More recent engine configurations may use M12 or even M10 spark plugs, where the well diameters could be less than 21 mm in diameter. Conventional pencil coils do not fit into spark plug wells 21 mm or less in diameter.

It is also known to provide an ignition apparatus where the transformer portion is not mounted within the spark plug well like a pencil coil, but rather is mounted outside of and above the spark plug well and has been referred to as a plug top coil. Known plug top ignition coils employ one long boot to mate to the spark plug. One challenge with the plug top ignition coil however, relates to packaging. Specifically, a relatively large area above the spark plug well is needed in order to mount the plug top ignition coil. In many applications, there is not enough clearance above the spark plug well to accommodate a typical plug top coil.

U.S. Pat. No. 6,575,151 issued to Murata et al. disclose an ignition coil for an internal combustion engine where an axis through the iron core is at a right angle but directly in line with an ignition plug axis line. The iron core is thus generally directly above the ignition plug axis line. This orientation, however, results in an ignition coil with an increased vertical height above the spark plug well.

There is therefore a need for an ignition apparatus that minimizes or eliminates one or more of the problems as set forth above.

### SUMMARY OF THE INVENTION

An object of the present invention is to solve one or more of the problems set forth in the Background. One advantage of the present invention is that it provides an ignition apparatus suitable for use in configuration having a small diameter spark plug well as well as other packaging constraints that limit the space above the spark plug well. The invention incorporates features that provide the required functionality of an ignition apparatus within a restricted space, specifically where conventional pencil coils are too large to fit in a reduced size spark plug well and conventional plug top coils are to big to fit above the spark plug well for one reason or another (e.g., interference from intake hood, etc.).

An ignition apparatus according to the invention is configured for mounting through a spark plug well that extends along a main axis. The ignition apparatus includes a pencil coil transformer assembly and a case. The transformer assembly is generally elongated and is disposed along a first axis and is configured to generate a spark voltage for firing a spark plug mounted to an engine. The case, which is configured to retain the transformer assembly, includes a high voltage (HV) connector terminal coupled to the transformer assembly, for conducting the spark voltage to the spark plug. The HV connector terminal extends along a second axis, which is configured to be in alignment with the main axis of the spark plug well upon installation. In accordance with the present invention, the first axis associated with the pencil coil transformer assembly is perpendicular to and offset from the second axis (of the HV connector assembly). In effect, the pencil coil transformer assembly is oriented in a “horizontal” position relative the “vertical” orientation of the spark plug well, and is offset therefrom. Through the foregoing, a reduction in the vertical space used is realized.

In another embodiment, the transformer assembly does not include a magnetic return path (i.e., no outer shield) which further enhances the already low profile (i.e., reduced vertical height).

In a still further embodiment, the ignition apparatus includes a printed circuit board (PCB) containing electronics (e.g., primary current driver chip) that are mounted parallel to the axis of the transformer to maintain a low profile and reduced width (as opposed to mounting the electronics at the axial end of the transformer assembly). In this still further embodiment, the case includes an electronics pocket separate from the transformer assembly and which is configured to receive the electronics. The pocket allows for the use of a separate potting material to that used for the transformer assembly, which for example allows the use of a potting material having thermal conductivity properties better suited to the electronics.

### BRIEF DESCRIPTION OF THE DRAWINGS

The present invention will now be described by way of example, with reference to the accompanying drawings, in which:

FIG. 1 is a diagrammatic, perspective view of an ignition apparatus in accordance with the present invention.

FIG. 2 is a diagrammatic side view of the ignition apparatus of FIG. 1.

FIG. 3 is a cross-section view of the ignition apparatus taken substantially along lines 3-3 in FIG. 2.

FIG. 4 is a cross-section view of the ignition apparatus taken substantially along lines 4-4 in FIG. 2.

FIG. 5 is a cross-section view of the ignition apparatus of FIG. 1 taken substantially along lines 5-5 in FIG. 1.

FIG. 6 is a partial perspective view, with portions of the case broken away for clarity, viewed from a similar perspective as FIG. 3.

FIG. 7 is a top plan view of the ignition apparatus as viewed substantially in the direction of lines 7-7 in FIG. 1.

### DETAILED DESCRIPTION OF THE PREFERRED EMBODIMENTS

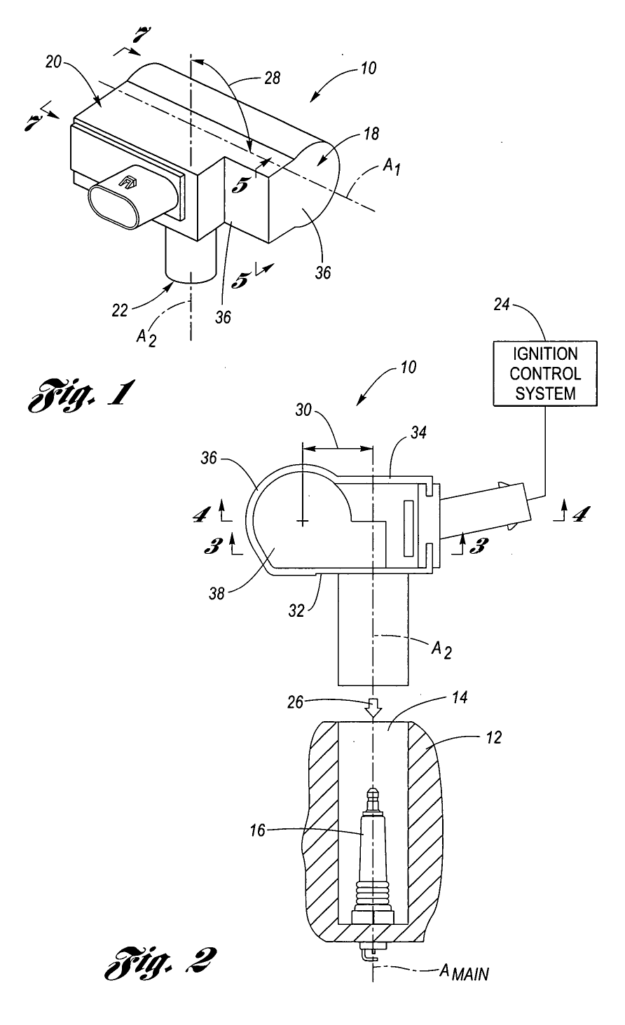

Referring now to the drawings wherein like reference numerals are used to identify identical components in the various views, FIG. 1 is a perspective view of an ignition apparatus 10 in accordance with the present invention. Apparatus 10 is configured to present a low profile (i.e., vertical height) as well as provide a reduced size high voltage tower so as to accommodate modern day packaging requirements (e.g., reduced diameter spark plug well).

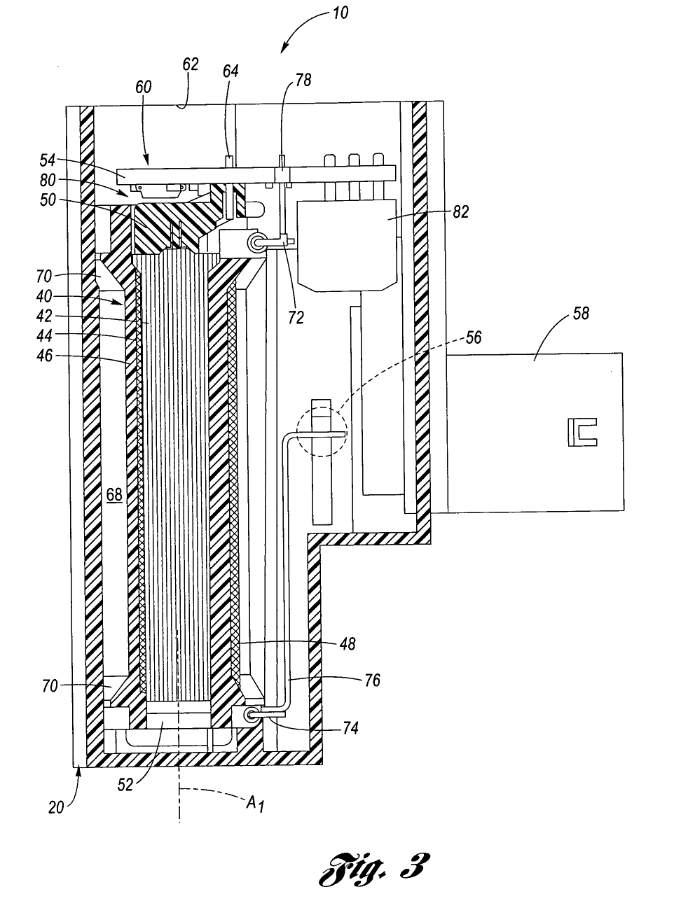

FIG. 2 is a side view of the ignition apparatus 10 shown in FIG. 1. Apparatus 10 is provided for use in an internal combustion engine 12 having a spark plug well 14 with a main axis, designated A_{MAIN}. FIG. 2 also shows a conventional spark plug 16. The spark plug well 14 provides access to the engine for installation of the spark plug 16, among other things.

With reference to FIGS. 1 and 2, ignition apparatus 10 includes a pencil coil transformer assembly 18 disposed along a first axis, designated A₁. Transformer assembly 18 is configured to generate a spark voltage suitable for firing spark plug 16. Spark plug 16 may be retained by a threaded engagement with a spark plug opening of an engine head. Ignition apparatus 10 further includes a case 20 configured to retain or house transformer assembly 18. Case 20 includes a high-voltage (HV) connector assembly 22 for providing the spark voltage directly to spark plug 16. The HV connector assembly 22 extends along a second axis designated A₂.

With reference to FIG. 2, apparatus 10 is configured for control by an ignition control system 24. System 24, for example, may provide power (e.g., battery voltage and ground) as well as an ignition control signal to apparatus 10 (e.g., to control initiation of charging and discharging of transformer assembly 18, the timing for the spark, etc.). Apparatus 10 is further configured for installation directly to spark plug 16 through spark plug well 14 by insertion in direction 26. Apparatus 10 is configured such that second axis A₂ becomes aligned with the main axis AMAIN of the spark plug well 14 upon installation.

With continued reference to FIGS. 1 and 2, it should be appreciated that ignition apparatus 10 is characterized by a generally “horizontal” pencil coil transformer assembly 18 relative to the generally “vertical” HV connector assembly 22 in spark plug well 14. Accordingly, first axis A₁ is perpendicular to and offset from the second axis A₂. This perpendicular relationship is shown by reference numeral 28 in FIG. 1 and the offset is shown by reference numeral 30 in FIG. 2. The offset 30 from the vertical axis A₂ provides for a reduced vertical height for apparatus 10 since the transformer assembly is to the side, and not directly above the well, allowing application in space restricted engine and/or engine compartment configurations. The present invention provides for a low profile ignition apparatus that will fit in an engine/compartment application where the spark plug well is too small for a conventional pencil coil (e.g., a spark plug well that is 21 mm or less) and the area above the spark plug well is too small (e.g., in vertical height) for a conventional plug top coil.

With continued reference to FIGS. 1 and 2, case 20 is defined by a base wall 32, an upper wall 34 and a plurality of sidewalls 36. Case 20 further includes a removable end wall 38 that is configured to close an opening in the case 20, as described in further detail below. Case 20 may be formed of electrical insulating material, and may comprise conventional materials known to those of ordinary skill in the art (e.g., PBT thermoplastic polyester material).

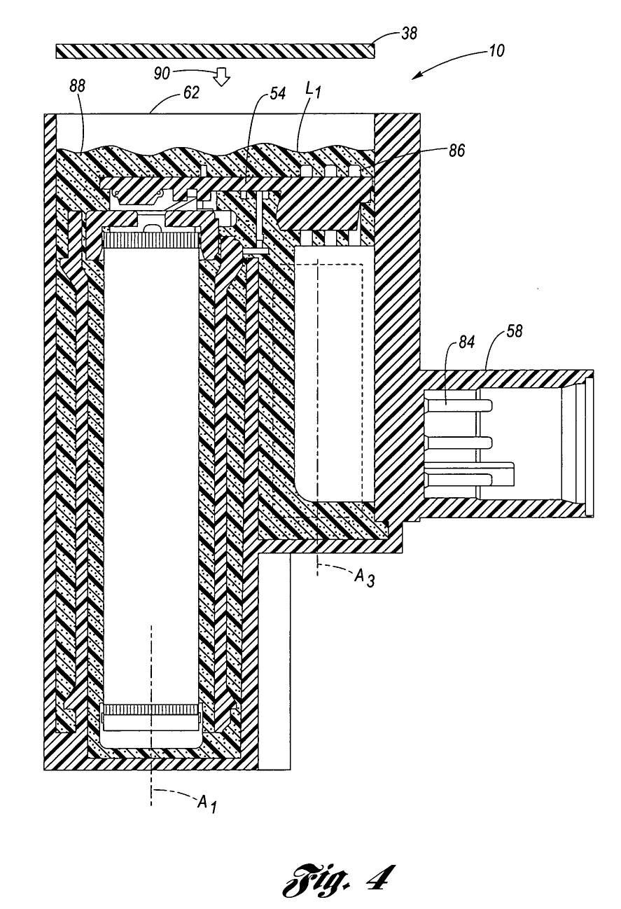

FIG. 3 is partial section view of apparatus 10 taken substantially along lines 3-3 in FIG. 2. FIG. 3 illustrates transformer assembly 18 including a coil assembly 40. Coil assembly 40 includes an elongated, magnetically-permeable, cylindrical central core 42, a primary winding 44, a secondary winding spool 46, a secondary winding 48, an upper cap 50 and a lower cap 52. FIG. 3 further shows a printed circuit board (PCB) 54, a high voltage (HV) connector assembly 56 and a low voltage (system) connector body 58.

Case 20 includes a cavity 60 and an opening 62. Cavity 60 is defined in an interior of case 20 and is configured in size and shape to receive coil assembly 40. Opening 62 is configured for providing access to cavity 60, for example, for insertion of the coil assembly 40, as well as for introducing potting material into the interior of apparatus 10.

With continued reference to FIG. 3, core 42 may be elongated, and have a main longitudinal axis (e.g., coincident with first axis A₁ in FIG. 1). Core 42 may be a conventional core known to those of ordinary skill in the art. Core 42 may therefore comprise magnetically permeable material, for example, a plurality of silicon steel laminations (as shown), or, insulated iron particles compression molded to a desired shape. In the illustrated embodiment, core 42 may take a generally cylindrical shape, which defines a generally circular shape in radial cross-section.

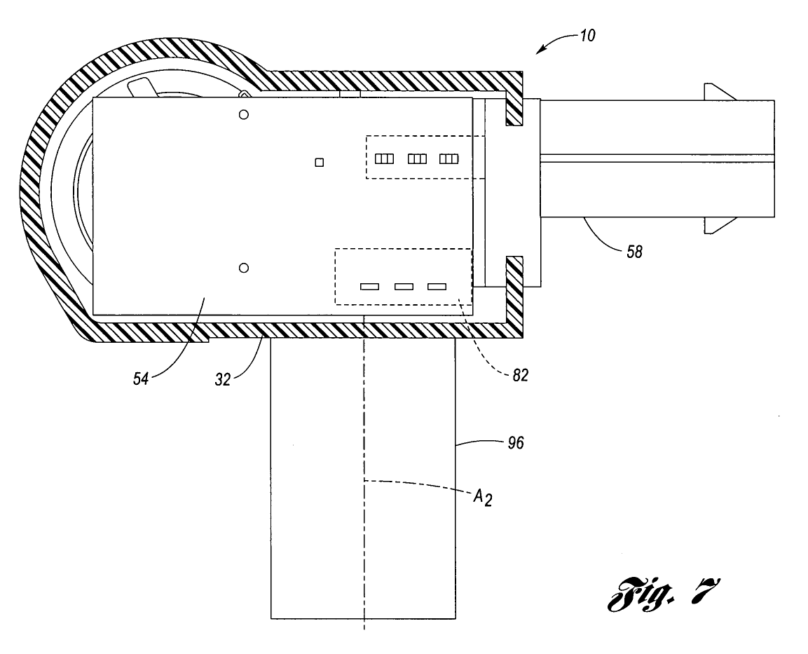

Primary winding 44 includes first end lead 64 and a second end lead 66 (best shown in FIG. 6). Primary winding 44 may be wound directly onto central core 42 or may be wound onto a primary winding spool (not shown in this embodiment). Primary winding 44 is configured to carry a primary current I_{P} for charging ignition apparatus 10 based upon the control established by ignition system 24. Primary winding 44 may be implemented using known approaches and conventional materials.

Secondary winding spool 46 is configured to receive and retain secondary winding 48. Spool 46 is disposed adjacent to and radially outwardly of the central components comprising core 42 and primary winding 44, and is preferably in coaxial relationship therewith.

Secondary spool 46 includes a generally cylindrical body having a winding bay defined by a winding surface 68 that is bounded by a pair of retaining flanges, designated by reference numeral 70. Retaining flanges 70 may be tapered, as taken with respect to the main longitudinal axis of the spool, as illustrated by reference to U.S. Pat. No. 6,232,863 to Skinner et al. entitled “SPOOL ASSEMBLY FOR AN IGNITION COIL,” herein incorporated by reference in its entirety. Secondary spool 46 is formed generally of electrical insulating material having properties suitable for use in a relatively high temperature environment. For example, spool 46 may comprise plastic material such as polybutylene terephthalate (PBT) thermoplastic polyester. It should be understood that there are a variety of alternative materials which may be used for spool 46 known to those of ordinary skill in the ignition art, the foregoing being exemplary only and not limiting in nature.

Secondary winding 48 includes a first, low voltage end and a second, high voltage end, which are terminated respectively on LV end terminal 72 and HV end terminal 74. End 72 may be coupled to either a reference ground node or a battery voltage, both of which are relatively low compared to a spark voltage. End 74 carries a high voltage (spark voltage) suitable for firing spark plug 16. In FIG. 3, HV end 74 is coupled to HV connector assembly by an intermediate connector 76. Secondary winding 48 is, in the illustrated embodiment, wound in a progressive wound pattern in accordance with the secondary winding spool 46 configuration. In an alternate embodiment, secondary winding spool 46 is configured to include a plurality of electrically isolated winding bays spaced axially along the length of spool 46 in order to accommodate a secondary winding 48 wound in a segmented winding pattern.

The primary and secondary windings 44 and 48 may both be disposed radially outwardly of central core 42 and coaxial therewith. In the illustrated embodiment, the secondary winding 48 is wound on secondary spool 46 that is radially, outwardly of the primary winding 44 (i.e., secondary outside of primary).

Cap 50 is configured to perform a retaining function specifically to substantially minimize or preclude any movement of primary winding 44 as well as core 42 within a central spool cavity of the secondary winding spool 46.

PCB 54 is included in the illustrated embodiment in a so-called electronics option to simplify the connections between the ignition apparatus 10 and ignition control system 24. PCB 54 is disposed in the case 20 between (i.e., axially intermediate) the case opening 62 and a first axial end of the coil assembly 14. PCB 54 includes, generally, electronics 80 having a switch comprising a main driver chip 82. Switch 82 may comprise an insulated gate bipolar transistor although it should be understood that other technologies may be employed and remain within the spirit and scope of the present invention.

In basic operation, switch 82 is selectively opened and closed based on the state of an electronic spark timing (EST) signal from ignition control system 24. As known in the art, closing switch 82 establishes a path to ground through primary winding 44. A primary current I_{P} is thereby established through the primary winding 44. When switch 82 is thereafter opened, the primary current I_{P} is interrupted, causing a relatively high voltage to be produced across secondary winding 48. This high voltage (spark voltage) across winding 48 is applied to spark plug 16 via HV connector assembly 56.

PCB 54, as illustrated, may be configured for direct connection to at least the primary winding leads 64, 66 by way of plated through-apertures, for example as in the manner described in U.S. Pat. No. 6,758,200 B2 entitled “IGNITION COIL DRIVER CHIP ON PRINTED CIRCUIT BOARD FOR PLUGHOLE COIL HOUSING” issued to Hageman et al., incorporated herein by reference in its entirety.

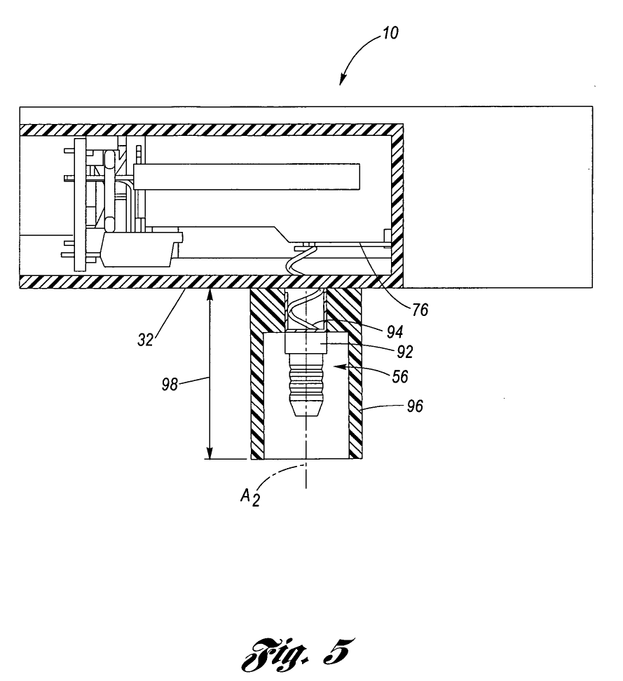

FIG. 4 is section view of ignition apparatus 10 taken substantially along lines 4-4 in FIG. 2. System connector 58, which includes conductive terminals or pins 84 is arranged for connection to a mating terminal (not shown) for communication of power (e.g., battery voltage and ground) and control signals (e.g. an electronic spark timing (EST) signal, as described above) between the ignition apparatus 10 and the ignition control system 24. The signals on the input pins 84 are carried internally in LV connector body 58 and appear as leads 86, which may be directly terminated to PCB 54 in the manner described above.

Apparatus 10 may further include potting material such as epoxy potting material 88, as is known in the art. In the illustrated embodiment, apparatus 10 is axially potted by the introduction of potting material 88 through axial opening 62 in the direction 90, for example in a manner described in U.S. Pat. No. 6,894,597 entitled “AXIALLY POTTED PROGRESSIVE WOUND REMOTE MOUNT IGNITION COIL” issued to Skinner et al., herein incorporated by reference in its entirety. The potting material 88 filling the cavity up to a level indicated as L₁ is operative for trapping and fixing the coil assembly 40 in the cavity 60. Opening 62 is then closed by inserting end wall 38 in the direction 90, and fixing its location through any suitable means.

It should be understood that as described above, the potting material 88 includes a predetermined level of thermal conductivity. In an alternate embodiment, case 20 includes a pocket (shown in dashed-line in FIG. 4) configured to receive the PCB 54 (and accompanying electronics 80) and which is located proximate the connector body 58 and having a third axis A₃ that is parallel to the first axis A₁. This alternate embodiment has additional advantages. First, it provides for a reduced axial length for apparatus 10 taken with respect to axis A₁. This additional reduction is size can prove useful for applications having limited space in the direction of axis A₁. Second, a second encapsulant different from the first encapsulant 88 (e.g., potting material 88) can be selected for the electronics pocket that is specifically chosen to allow the driver chip 82 to be mounted directly to the PCB 54, as per U.S. Pat. No. 6,758,200 referred to above. That is, the second encapsulant can have a second thermal conductivity different from the thermal conductivity of the first material 88 that is particularly suited for electronics and heat conduction for a current-carrying chip such as chip 82.

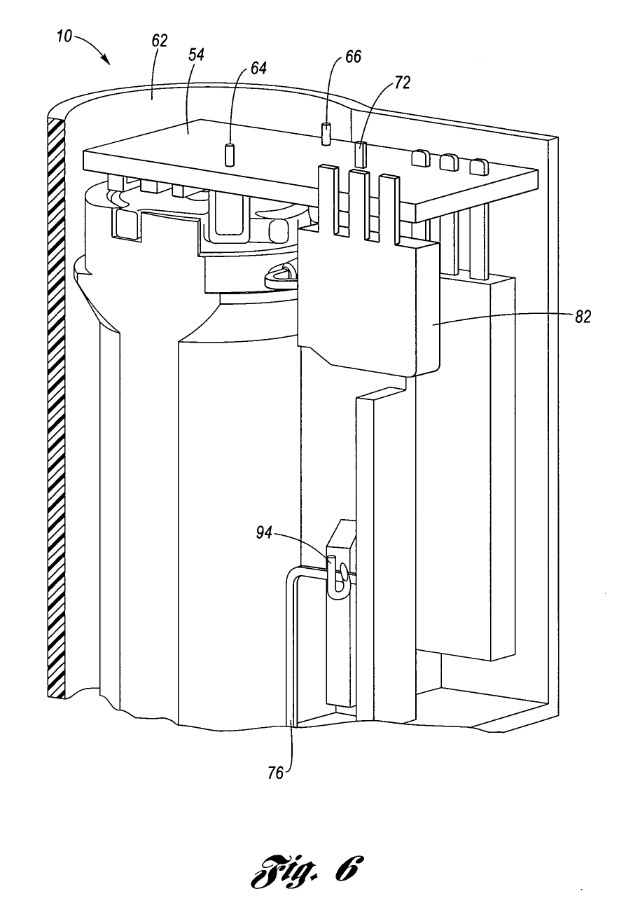

FIG. 5 is a partial section view taken substantially along lines 5-5 in FIG. 1. High voltage connector assembly 56 includes a high voltage connector terminal 92 and an electrically conductive spring 94. HV assembly 56 further includes a high voltage tower 96 projecting a distance 98 from a central region of an outer surface of base wall 32. A high voltage coupler (not shown), for example a spring or the like, may be provided for electrically connecting the HV connector terminal 92 to the spark plug 16. In combination, HV assembly 56 is configured for direct connection of the ignition apparatus 10 to spark plug 16 via insertion of the tower 96 in the spark plug well 14, thereby eliminating the need for a separate bolt or other fastener to secure ignition apparatus 10 to engine 12. FIG. 5 further shows where spring 94 is coupled to HV connector 76, which in turn is electrically connected to HV lead 74. It should be observed that the HV connector terminal 92 extends along the second axis A₂ described above in connection with FIGS. 1 and 2.

The foregoing arrangement for coupling the high voltage (spark voltage) developed by secondary winding 48 is exemplary only; a number of alternative connector arrangements, particularly spring-biased arrangements, are known in the art.

HV assembly 56 may further include a boot or the like (not shown), which is known to be formed of silicone material or other compliant and electrically insulative material.

FIG. 6 is a side view in substantially the same direction as in FIG. 3 but with portions of the case and LV connector body broken away and/or omitted, as the case may be. FIG. 6 more clearly shows both primary winding leads 64 and 66 terminated on PCB 54, as described above. FIG. 6 further shows in greater detail how spring 94 connects with HV connector 76.

FIG. 7 is a top plan view of ignition apparatus 10, with end plate 38 omitted for improved clarity.

It should be understood that variations of the illustrated embodiment are possible without departing from the spirit and scope of the present invention. For example, ignition apparatus 10 may be configured for use in a multicharging configuration (i.e., repetitive spark during a single combustion event). In another embodiment, the pencil coil transformer assembly 18 may be provided as two or more separate, individual coil assemblies (e.g., mounted horizontally side by side) and connected electrically in series and operated as one transformer. Additionally, in a still further embodiment, the central core may be configured in an oblong geometry (when taken in radial cross-section) rather than a cylindrical geometry as in the illustrated embodiment.

1. An ignition apparatus for an internal combustion engine with a spark plug well having a main axis, comprising:
a pencil coil transformer assembly disposed along a first axis and configured to generate a spark voltage;
a case configured to retain said transformer assembly, said case including a high voltage (HV) connector terminal coupled to said transformer assembly for receiving said spark voltage, said HV connector terminal extending along a second axis configured for alignment with said main axis of the spark plug well;
said first axis being perpendicular to and offset from said second axis.

2. The ignition apparatus of claim 1 wherein said transformer assembly comprises:
an elongated cylindrical central core extending along said first axis and comprising magnetically permeable material;
a primary winding disposed radially outwardly of said core;
a secondary winding spool;
a secondary winding disposed radially outwardly of said core and having a high voltage end on which said spark voltage is generated, said secondary winding being wound on said spool, and wherein said case is outwardly of said core, said spool and said primary and secondary windings.

3. The apparatus of claim 2 wherein said case includes a tower surrounding said HV connector terminal, said HV connector terminal and said tower being configured for direct connection to a spark plug via installation in the spark plug well.

4. The apparatus of claim 3 further including a boot coupled to said tower, and a high voltage coupler attached to said HV connector terminal, said boot and said HV coupler providing mechanical and electrical connection of said ignition apparatus to said spark plug.

5. The apparatus of claim 3 wherein said case includes a base wall, said tower projecting from a central region of an outer surface of said base wall.

6. The apparatus of claim 2 wherein said central core, said spool and said primary and secondary windings define a coil assembly, said case including a cavity in an interior thereof configured to receive said coil assembly, said case having an opening for access to said cavity, said apparatus further including a printed circuit board configured for direct connection to at least primary winding leads via plated through-apertures, said printed circuit board being disposed in said interior of said case intermediate said opening and said coil assembly.

7. The apparatus of claim 2 wherein said central core, said spool and said primary and secondary windings define a coil assembly, said case including a cavity in an interior thereof configured to receive said coil assembly, said case having an opening for access to said cavity, said apparatus further including potting material filling said opening of said cavity and trapping said coil assembly in said cavity.

8. The apparatus of claim 7 wherein said case further includes an end wall configured to close said opening.

9. The apparatus of claim 2 wherein said central core, said spool and said primary and secondary windings define a coil assembly, said case including a cavity in an interior thereof configured to receive said coil assembly, said case having an opening for access to said cavity, said case further including a pocket defined in said interior separate from said cavity for said coil assembly, said pocket being configured to receive a printed circuit board configured for direct connection to at least primary winding leads via plated through-apertures, said pocket being proximate a low voltage connector body and having a third axis parallel to said first axis.

10. The apparatus of claim 9 wherein said cavity further includes a first potting material having a first thermal conductivity, said pocket further includes a second potting material having a second thermal conductivity different from said first thermal conductivity.

11. The apparatus of claim 10 further including a switch for selectively causing a primary current to flow through said primary winding, said switch being directly mounted to said printed circuit board.

12. The apparatus of claim 2 wherein said secondary winding is wound on said spool in a progressive winding pattern.

13. The apparatus of claim 2 wherein said secondary winding spool is configured to provide a plurality of axially spaced winding bays and wherein said secondary winding is wound on said spool in a segmented winding pattern.

14. The apparatus of claim 2 wherein said pencil coil transformer assembly is configured to repetitively generate said spark voltage during a single combustion event.
